(19) United States
(12) Patent Application Publication
(10) Pub. No.: US 2014/0152289 A1
(43) Pub. Date: Jun. 5, 2014

(54) Reference Voltage Generator Circuit

(71) Applicant: iWatt Integrated Circuits Technology (Tianjin) Limited, Tianjin (CN)

(72) Inventors: Weihai Huang, Tianjin (CN); Honglai Wang, Tianjin (CN)

(73) Assignee: iWatt Integrated Circuits Technology (Tianjin) Limited, Tianjin (CN)

(21) Appl. No.: 14/097,095

(22) Filed: Dec. 4, 2013

(30) Foreign Application Priority Data
Dec. 5, 2012 (CN) 201210518299.0

(51) Int. Cl. G05F 3/26

(52) U.S. Cl. CPC G05F 3/267
USPC 323/313

(57) ABSTRACT

Various embodiments of the present invention relate to a reference voltage generator circuit. Specifically, the circuit may for example comprise: a mirror constant current source having a first branch and a second branch, wherein a first current on the first branch is proportional to a second current on the second branch; wherein the first branch has a first resistive element, and the second branch has two second resistive elements connected in series; and a power supply terminal located between said two second resistive elements on the second branch. A high-precision reference voltage relative to the voltage source can be provided at the power supply terminal by using the circuit provided by various embodiments of the present invention.

### FIELD OF THE INVENTION

Embodiments of the present invention generally relate to the field of circuits, and more specifically to a reference voltage generator circuit.

### BACKGROUND OF THE INVENTION

As semiconductor technologies develop swiftly, various integrated circuits (IC) are universally applied in industrial production and people's daily life. However in an IC (particularly, a high voltage IC), a high-accuracy reference voltage relative to a voltage source often needs to be generated. Currently, a conventional reference voltage generator circuits in the industry implements generation of the high-accuracy reference voltage via in-series resistors. However, it is very difficult to generate the high-accuracy reference voltage since a current in the circuit and a value of the resistor vary at different process corners and temperatures.

### SUMMARY OF THE INVENTION

In order to address the above problems, embodiments of the present invention aim to provide a reference voltage generator circuit in the context of the specification.

According some embodiments in one aspect of the present invention, there is provided a reference voltage generator circuit which for example may comprise: a mirror constant current source having a first branch and a second branch, wherein a first current on the first branch is proportional to a second current on the second branch; wherein the first branch has a first resistive element, and the second branch has two second resistive elements connected in series; and a power supply terminal located between said two second resistive elements on the second branch.

According some embodiments in one aspect of the present invention, there is provided a reference voltage generator circuit which for example may comprise the following: wherein a proportion of the first current on the first branch to the second current on the second branch is M:N, wherein M and N are integers greater than or equal to 1.

According some embodiments in one aspect of the present invention, there is provided a reference voltage generator circuit which for example may comprise the following: wherein the first branch has a first NPN bipolar transistor thereon, the second branch has a second NPN bipolar transistor thereon, the first NPN bipolar transistor and the second NPN bipolar transistor match each other, wherein a voltage between a base and an emitter is V_{be}; wherein a base of the first NPN bipolar transistor is connected to a base of the second NPN bipolar transistor and connected to its own collector; an emitter of the first NPN bipolar transistor is connected to an emitter of the second NPN bipolar transistor; a collector of the first NPN bipolar transistor is connected to a high-accuracy reference voltage V_{R} via the first resistive element; and a collector of the second NPN bipolar transistor is connected to a voltage source V_{DDH} via the two second resistive elements.

According some embodiments in one aspect of the present invention, there is provided a reference voltage generator circuit which for example may comprise the following: wherein at least one of the following is included between the two second resistive elements and the voltage source V_{DDH}: a third NPN bipolar transistor matchable with the first NPN bipolar transistor or the second NPN bipolar transistor, wherein a voltage between a base and an emitter is V_{be}, its base and collector are connected to the voltage source V_{DDH}, its emitter is connected to the two second resistive elements; and a diode matchable with the first NPN bipolar transistor or the second NPN bipolar transistor, wherein a voltage between a positive pole and a negative pole is V_{d}, its positive pole is connected to the voltage source V_{DDH}, and its negative pole is connected to the two second resistive elements.

According some embodiments in one aspect of the present invention, there is provided a reference voltage generator circuit which for example may comprise the following: wherein the first branch has a first N-MOS transistor thereon, the second branch has a second N-MOS transistor thereon, and the first N-MOS transistor and the second N-MOS transistor match each other, wherein a voltage between a gate and a source is V_{gs}; wherein a gate of the first N-MOS transistor is connected to a gate of the second N-MOS transistor and connected to its own drain; a source of the first N-MOS transistor is connected to a source of the second N-MOS transistor; a drain of the first N-MOS transistor is connected to a high-accuracy reference voltage VR via the first resistive element; and the drain of the second N-MOS transistor is connected to a voltage source V_{DDH} via the two second resistive elements.

According some embodiments in one aspect of the present invention, there is provided a reference voltage generator circuit which for example may comprise the following: wherein at least one of the following is included between the two second resistive elements and the voltage source V_{DDH}: a P-MOS transistor matchable with the first N-MOS transistor or the second N-MOS transistor, wherein a voltage between the gate and source is V_{gs}, its source is connected to the voltage source V_{DDH}, and its gate and drain are connected to the two second resistive elements; and a diode matchable with the first N-MOS transistor or the second N-MOS transistor, wherein a voltage between a positive pole and a negative pole is V_{d}, its positive pole is connected to the voltage source V_{DDH}, and its negative pole is connected to the two second resistive elements.

According some embodiments in one aspect of the present invention, there is provided a reference voltage generator circuit which for example may comprise the following: further comprising generating a desired reference voltage V_{REF} relative to the voltage source V_{DDH} at the power supply terminal by adjusting a ratio of the two second resistive elements on the second branch to the first resistive element on the first branch.

According some embodiments in one aspect of the present invention, there is provided a reference voltage generator circuit which for example may comprise the following: wherein the adjusting comprise: adjusting a ratio of the second resistive elements on the second branch between the voltage source V_{DDH} and the reference voltage to the first resistive element on the first branch to make the ratio equal to a ratio of a difference between the V_{DDH} and the V_{REF} plus the V_{d}/V_{be}/V_{gs} to a difference between the V_{R} and V_{d}/V_{be}/V_{gs}; and adjusting a ratio of another second resistive element on the second branch to the first resistive element on the first branch to make the ratio equal to a ratio of a difference between the V_{REF} and the V_{d}/V_{be}/V_{gs} to the difference between V_{R} and the V_{d}/V_{be}/V_{gs}.

According some embodiments in one aspect of the present invention, there is provided a reference voltage generator circuit which for example may comprise: wherein the reference voltage generator circuit is located on a substrate of the same region of an integrated circuit.

According some embodiments in one aspect of the present invention, there is provided a reference voltage generator circuit which for example may comprise: wherein the resistive elements are resistors.

According some embodiments in one aspect of the present invention, there is provided an integrated circuit which for example may comprise the reference voltage generator circuit according to the preceding text.

Exemplary solutions provided by exemplary embodiments of the present invention at least may bring about the following remarkable technical effects: a high-accuracy reference source may be obtained at the power supply terminal by allowing the mirror constant current source to generate two branches with identical current or proportional currents, and then by adjusting a ratio of resistance on the second branch to the first branch; and the high-accuracy reference voltage may be any needed or desired value. This is very important for a high-voltage IC and flexible in practical application.

### BRIEF DESCRIPTION OF DRAWINGS

The above and other objects, features and advantages of exemplary embodiments of the present invention will be made more apparent by reading through detailed description with reference to figures. In the figures, several embodiments of the present invention are illustrated in an exemplary but non-restrictive manner, wherein:

FIG. 1 illustrates a reference voltage generator circuit according to the prior art;

FIG. 2 illustrates a reference voltage generator circuit according to an exemplary embodiment of the present invention;

FIG. 3 illustrates another reference voltage generator circuit according to an exemplary embodiment of the present invention;

FIG. 4 illustrates a further reference voltage generator circuit according to an exemplary embodiment of the present invention; and

FIG. 5 illustrates a further reference voltage generator circuit according to an exemplary embodiment of the present invention.

In the figures, an identical or corresponding reference sign designates an identical or corresponding part.

### DETAILED DESCRIPTION OF PREFERRED EMBODIMENTS

Principles and spirit of the present invention will be described with reference to several exemplary embodiments. It should be appreciated that these embodiments are presented only to enable those skilled in the art to better understand and thereby implement the present invention, not to limit the scope of the present invention in any manner.

Specific embodiments of the present invention are described below with reference to figures.

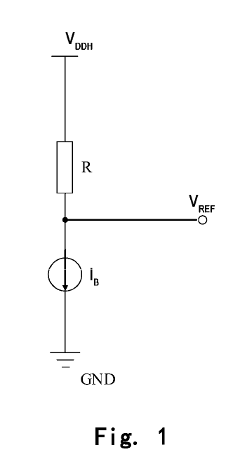

FIG. 1 illustrates a reference voltage generator circuit according to the prior art. As shown in FIG. 1, a resistor R is connected in series in the circuit. The following may be obtained according to Ohm's law:

V_{DDH}−V_{REF}=I_{B}*R

Wherein I_{B} is current, and R is a resistance. However, since a current in the circuit and a value of the resistor vary at different process corners and temperatures (namely, values of I_{B} and R are coarse), the V_{DDH}−V_{REF} generated at the power supply terminal is a low-accuracy reference voltage.

In order to eliminate an influence exerted by the current in the circuit and the value of the resistor varying at different process corners and temperatures, exemplary embodiments of the present invention provide a reference voltage generator circuit which for example may comprise: a mirror constant current source having a first branch and a second branch, wherein a first current on the first branch is proportional to a second current on the second branch; wherein the first branch has a first resistive element, and the second branch has two second resistive elements connected in series; and a power supply terminal located between said two second resistive elements on the second branch. Specifically, a proportion of the first current on the first branch to the second current on the second branch may be M:N, wherein M and N are integers greater than or equal to 1 and their values depend on a ratio of junction areas of transistors in the first branch and second branch in the mirror constant current source or an aspect ratio of a channel of an MOS transistor.

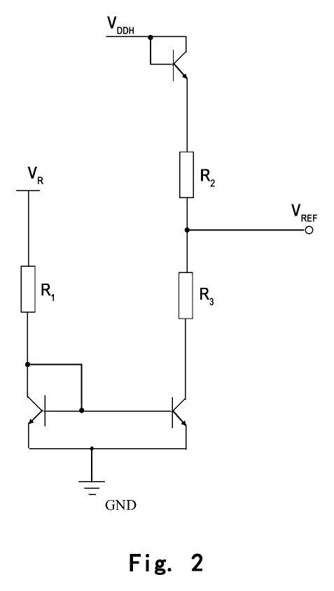

FIG. 2 illustrates a reference voltage generator circuit according to an exemplary embodiment of the present invention. In an example shown in FIG. 2, the proportion of the first current on the first branch to the second current on the second branch is 1:1 (namely, the first current value is equal to the second current value). As shown in FIG. 2, the first branch has a first NPN bipolar transistor thereon, the second branch has a second NPN bipolar transistor thereon, the first NPN bipolar transistor and the second NPN bipolar transistor may match each other (e.g., identical), wherein a voltage between a base and an emitter is V_{be}; wherein a base of the first NPN bipolar transistor may be connected to a base of the second NPN bipolar transistor and connected to its own collector; an emitter of the first NPN bipolar transistor may be connected to an emitter of the second NPN bipolar transistor; a collector of the first NPN bipolar transistor may be connected to a high-accuracy reference voltage VR via the first resistive element; and a collector of the second NPN bipolar transistor may be connected to a voltage source V_{DDH} via the two second resistive elements.

Since the NPN bipolar transistors shown in FIG. 2 match one another (e.g., identical) and are located on a substrate of an identical region of an integrated circuit, I_{R1}=I_{R2}=I_{R3}, wherein V_{R} is the high-accuracy reference voltage which may be offered from a Bandgap reference source or a laser trimmed low-voltage power supply.

If a voltage V_{be} between the base and the emitter of the NPN bipolar transistors shown in FIG. 2 is equal, the following can be obtained:

(V_{DDH}−V_{REF}−V_{be})/R₂=(V_{R}−V_{be})/R₁; and

(V_{REF}−V_{be})/R₃=(V_{R}−V_{be})/R₁

Therefore,

R₂/R₁=(V_{DDH}−V_{REF}−V_{be})/(V_{R}−V_{be}); and

R₃/R₁=(V_{REF}−V_{be})/(V_{R}−V_{be})

For example, if V_{be}=0.7V, V_{DDH}=35V and V_{R}=5V, and the reference voltage (V_{DDH}−V_{REF})=5V is expected to be obtained, the ratio of the resistive elements in the two branches may be adjusted so that R₂/R₁=1, and R₃/R₁=6.8. Additionally or alternatively, for example, if the reference voltage (V_{DDH}−V_{REF})=6V is excepted to be obtained, the ratio of the resistive elements in the two branches may be adjusted so that R₂/R₁=1.2, and R₃/R₁=6.6. Preferably, in the same process flow, they are implemented in the same region of the same integrated circuit so that the values of R₂/R₁ and R₃/R₁ are less subjected to the influence of environment (e.g., voltage, process, temperature) and achieve a higher accuracy. Besides, the reference voltage V_{R} may be offered from a Bandgap reference source or a laser trimmed low-voltage power supply, so V^{R} has a high accuracy. Hence, the high-accuracy reference voltage may be obtained at the power supply terminal, and the high-accuracy reference voltage may be any needed or desired value. This is very important for a high-voltage IC and flexible in practical application.

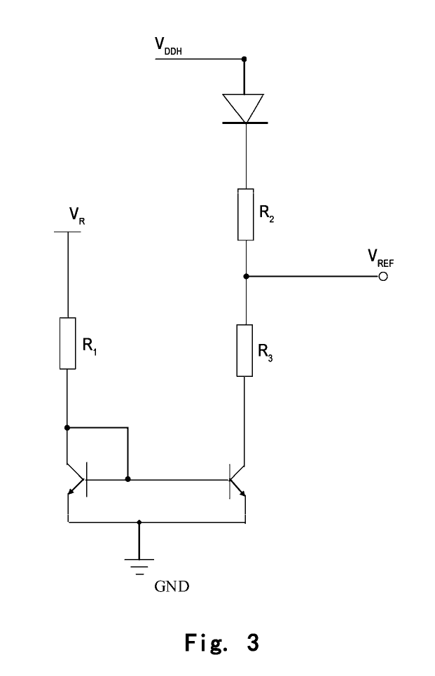

FIG. 3 illustrates another reference voltage generator circuit according to an exemplary embodiment of the present invention, wherein the proportion of the first current on the first branch to the second current on the second branch is 1:1 (namely, the first current value is equal to the second current value). Alternatively, a diode may be included between R₂ and the voltage source V_{DDH}, and it is matchable with the first NPN bipolar transistor or the second NPN bipolar transistor shown in FIG. 2, wherein a voltage between a positive pole and a negative pole is V_{d}, its positive pole is connected to the voltage source V_{DDH}, and its negative pole is connected to the two second resistive elements.

A PN junction diode is provided between the base and emitter of the NPN bipolar transistor, so a voltage difference V_{be} thereof is approximate to or equal to the voltage V_{d} between the positive pole and negative pole of the diode shown in FIG. 3, and the high-accuracy reference voltage may be obtained at the power supply terminal according to the above formulas with reference to FIG. 2, and the high-accuracy reference voltage may be any needed or desired value.

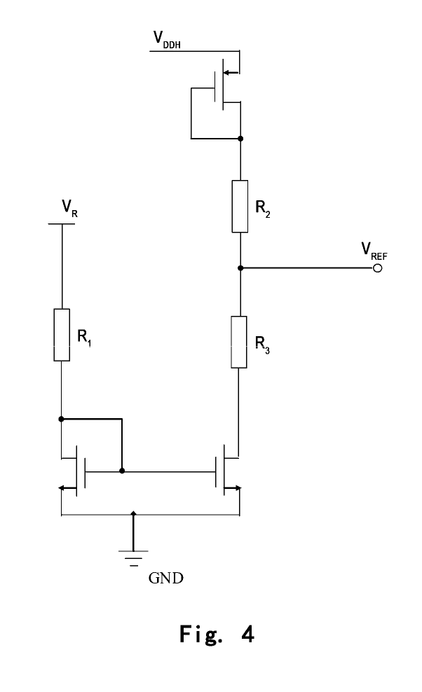

FIG. 4 illustrates a further reference voltage generator circuit according to an exemplary embodiment of the present invention. In one example, the proportion of the first current on the first branch to the second current on the second branch is 1:1 (namely, the first current value is equal to the second current value). As shown in FIG. 4, the first branch may have a first N-MOS transistor thereon, the second branch may have a second N-MOS transistor thereon, and the first N-MOS transistor and the second N-MOS transistor match each other, wherein a voltage between a gate and a source is V_{gs}; wherein a gate of the first N-MOS transistor is connected to a gate of the second N-MOS transistor and connected to its own drain; a source of the first N-MOS transistor is connected to a source of the second N-MOS transistor; a drain of the first N-MOS transistor is connected to a high-accuracy reference voltage V_{R} via the first resistive element; and the drain of the second N-MOS transistor is connected to a voltage source V_{DDH} via the two second resistive elements.

Since the N-MOS transistor and a P-MOS transistor shown in FIG. 4 match each other (e.g., identical) and are located on a substrate of an identical region of an integrated circuit, I_{R1}=I_{R2}=I_{R3}, wherein V_{R} is the high-accuracy reference voltage which may be offered from a Bandgap reference source or a laser trimmed low-voltage power supply.

If a voltage V_{gs} between the gate and source of the N-MOS transistor and P-MOS transistor shown in FIG. 4 is approximate and equal, the high-accuracy reference voltage may be obtained at the power supply terminal according to the above formulas with reference to FIG. 2, and the high-accuracy reference voltage may be any needed or desired value.

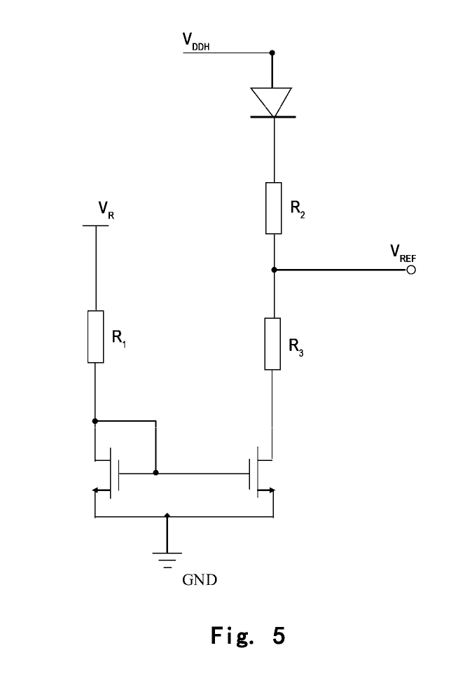

FIG. 5 illustrates a further reference voltage generator circuit according to an exemplary embodiment of the present invention, wherein the proportion of the first current on the first branch to the second current on the second branch is 1:1 (namely, the first current is equal to the second current). Alternatively, a diode may be included between R₂ and the voltage source V_{DDH}, and it is matchable with the first N-MOS transistor or the second N-MOS transistor, wherein a voltage between a positive pole and a negative pole is V_{d}, its positive pole is connected to the voltage source V_{DDH}, and its negative pole is connected to the two second resistive elements.

If the voltage V_{d} between the positive pole and negative pole of the diode shown in FIG. 5 is approximate to or equal to the voltage V_{gs} between the gate and source of the N-MOS transistor, the high-accuracy reference voltage may be obtained at the power supply terminal according to the above formulas with reference to FIG. 2, and the high-accuracy reference voltage may be any needed or desired value.

Embodiments of the present invention provide an integrated circuit comprising the reference voltage generator circuit stated in the preceding text.

Those skilled in the art may appreciate that the resistive elements in the exemplary embodiments of the present invention may be resistors.

It should be understood from the above depictions that modifications and variations may be made to embodiments of the present invention without departing from true spirit of the present invention. The depictions in the description are only illustrative and should not be regarded as being restrictive. Although the present invention has been depicted with reference to specific embodiments, it should be understood that the present invention is not limited to the disclosed specific embodiments. The present invention intends to cover various modifications and equivalent arrangements included in the spirit and scope of the appended claims. The scope of the appended claims meets the broadest explanations and covers all such modifications and equivalent structures and functions.

What is claimed is:

1. A reference voltage generator circuit, comprising:
a mirror constant current source having a first branch and a second branch, wherein a first current on the first branch is proportional to a second current on the second branch;
wherein the first branch has a first resistive element, and the second branch has two second resistive elements connected in series; and
a power supply terminal located between said two second resistive elements on the second branch.

2. The reference voltage generator circuit according to claim 1, wherein a proportion of the first current on the first branch to the second current on the second branch is M:N, wherein M and N are integers greater than or equal to 1.

3. The reference voltage generator circuit according to claim 1, wherein the first branch has a first NPN bipolar transistor thereon, the second branch has a second NPN bipolar transistor thereon, the first NPN bipolar transistor and the second NPN bipolar transistor match each other, wherein a voltage between a base and an emitter is V_{be};
wherein a base of the first NPN bipolar transistor is connected to a base of the second NPN bipolar transistor and connected to its own collector;
an emitter of the first NPN bipolar transistor is connected to an emitter of the second NPN bipolar transistor;
a collector of the first NPN bipolar transistor is connected to a high-accuracy reference voltage V_{R} via the first resistive element; and
a collector of the second NPN bipolar transistor is connected to a voltage source V_{DDH} via the two second resistive elements.

4. The reference voltage generator circuit according to claim 3, wherein at least one of the following is included between the two second resistive elements and the voltage source V_{DDH}:
a third NPN bipolar transistor matchable with the first NPN bipolar transistor or the second NPN bipolar transistor, wherein a voltage between a base and an emitter is V_{be}, its base and collector are connected to the voltage source V_{DDH}, its emitter is connected to the two second resistive elements; and
a diode matchable with the first NPN bipolar transistor or the second NPN bipolar transistor, wherein a voltage between a positive pole and a negative pole is V_{d}, its positive pole is connected to the voltage source V_{DDH}, and its negative pole is connected to the two second resistive elements.

5. The reference voltage generator circuit according to claim 1, wherein the first branch has a first N-MOS transistor thereon, the second branch has a second N-MOS transistor thereon, and the first N-MOS transistor and the second N-MOS transistor match each other, wherein a voltage between a gate and a source is V_{gs};
wherein a gate of the first N-MOS transistor is connected to a gate of the second N-MOS transistor and connected to its own drain;
a source of the first N-MOS transistor is connected to a source of the second N-MOS transistor;
a drain of the first N-MOS transistor is connected to a high-accuracy reference voltage V_{R} via the first resistive element; and
the drain of the second N-MOS transistor is connected to a voltage source V_{DDH} via the two second resistive elements.

6. The reference voltage generator circuit according to claim 5, wherein at least one of the following is included between the two second resistive elements and the voltage source V_{DDH}:
a P-MOS transistor matchable with the first N-MOS transistor or the second N-MOS transistor, wherein a voltage between the gate and source is V_{gs}, its source is connected to the voltage source V_{DDH}, and its gate and drain are connected to the two second resistive elements; and
a diode matchable with the first N-MOS transistor or the second N-MOS transistor, wherein a voltage between a positive pole and a negative pole is V_{d}, its positive pole is connected to the voltage source V_{DDH}, and its negative pole is connected to the two second resistive elements.

7. The reference voltage generator circuit according to claim 1, further comprising generating a desired reference voltage V_{REF} relative to the voltage source V_{DDH} at the power supply terminal by adjusting a ratio of the two second resistive elements on the second branch to the first resistive element on the first branch.

8. The reference voltage generator circuit according to claim 7, wherein the adjusting comprise:
adjusting a ratio of the second resistive elements on the second branch between the voltage source V_{DDH} and the reference voltage to the first resistive element on the first branch to make the ratio equal to a ratio of a difference between the V_{DDH} and the V_{REF} plus V_{d}/V_{be}/V_{gs} to a difference between V_{R} and V_{d}/V_{be}/V_{gs}; and
adjusting a ratio of another second resistive element on the second branch to the first resistive element on the first branch to make the ratio equal to a ratio of a difference between the V_{REF} and the V_{d}/V_{be}/V_{gs} to the difference between V_{R} and the V_{d}/V_{be}/V_{gs}.

9. The reference voltage generator circuit according to claim 1, wherein the reference voltage generator circuit is located on a substrate of the same region of an integrated circuit.

10. The reference voltage generator circuit according to claim 1, wherein the resistive elements are resistors.

11. An integrated circuit, comprising the reference voltage generator circuit according to one of claims 1-10.
